(19) United States
(12) Patent Application Publication
(10) Pub. No.: US 2024/0111050 A1
(43) Pub. Date: Apr. 4, 2024

(54) SELF-PROPELLED FLOOR PROCESSING DEVICE WITH AN OPTICAL DISTANCE MEASURING DEVICE

(71) Applicant: Vorwerk & Co. Interholding GmbH, Wuppertal (DE)

(72) Inventors: Andrej MOSEBACH, Unna (DE); Jascha BARTELS, Essen (DE); Markus WALLENTIN, Essen (DE)

(73) Assignee: Vorwerk & Co. Interholding GmbH, Wuppertal (DE)

(21) Appl. No.: 18/369,875

(22) Filed: Sep. 19, 2023

(30) Foreign Application Priority Data
Sep. 26, 2022 (EP) 22197735.8

(51) Int. Cl. G01S 17/48; G01S 7/481; G05D 1/02

(52) U.S. Cl. CPC G01S 17/48; G01S 7/4813; G01S 7/4817; G05D 1/0238; G05D 2201/0215

(57) ABSTRACT

A self-propelled floor processing device with an optical distance measuring device for detecting a distance between the floor processing device and an obstacle in the environment. The distance measuring device has a first triangulation device with a first light source, a first light receiver and a first lens, a second triangulation device with a second light source, a second light receiver and a second lens, and an evaluation device. Each lens bundles light of the light source reflected by an obstacle in the direction of the allocated light receiver, and images it on an imaging location on the light receiver. The evaluation device determines a distance to the obstacle based on the imaging location. The first triangulation device detects an obstacle in a close distance range to the floor processing device, and the second triangulation device detects an obstacle in a long distance range to the floor processing device.

### CROSS REFERENCE TO RELATED APPLICATIONS

Applicant claims priority under 35 U.S.C. § 119 of European Application No. 22197735.8 filed Sep. 26, 2022, the disclosure of which is incorporated by reference.

### BACKGROUND OF THE INVENTION

### 1. Field of the Invention

The invention relates to a self-propelled floor processing device with an optical distance measuring device for detecting a distance between the floor processing device and an obstacle in the environment, wherein the distance measuring device has a first triangulation device with a first light source, a first light receiver and a first lens allocated to the first light receiver, a second triangulation device designed separately from the first triangulation device with a second light source, a second light receiver and a second lens allocated to the second light receiver, and an evaluation device, wherein the lens belonging to the respective triangulation device bundles light of the light source reflected by an obstacle in the direction of the allocated light receiver, and images it on an imaging location on the light receiver, and wherein the evaluation device is configured to determine a distance to the obstacle based on the imaging location.

### 2. Description of the Related Art

Self-propelled floor processing devices are sufficiently known in prior art. These are autonomous floor processing robots, for example such as cleaning devices, mowing devices, polishing devices, waxing devices or the like. Generic cleaning devices can further be differentiated into vacuuming devices and wipe cleaning devices, for example. The self-propelled floor processing devices usually have a navigation device, which the floor processing device can use to localize itself in the environment and navigate through the environment. In this conjunction, the distance measuring device serves to detect distances to obstacles in the environment, based on which an area map is then generated, which the floor processing device can use to orient itself.

It is further known to design a distance measuring device of a floor processing device as a triangulation device, which has a light source, a light receiver and a lens allocated to the light receiver, which bundles light reflected by an obstacle in the direction of the light receiver. Light emitted by the light source hits the obstacle, and at least in terms of reflection shares arrives at the light receiver, wherein the light receiver usually has a flat chip, for example a CCD chip or CMOS chip. The precise position of the light share reflected back to the chip provides information about the distance between the obstacle and the floor processing device. The distance is here determined through triangulation. Such optical triangulation devices are designed in particular for the close distance range. They are less suitable for the long distance range, since the characteristic curve for determining the distance runs increasingly flat as the distance between the obstacle and the floor processing device increases, which makes it more difficult to precisely determine the distance. It is here of vital importance that sharper angles must exist between the light source, obstacle, and light receiver for detecting shorter distances, i.e., in a close distance range of approx. 0.2 m up to about 5 m, than is the case for detecting obstacles in a long distance range, starting at 5 m. The geometric arrangement of the optical components of the triangulation device can thus not be optimized to the close distance range on the one hand, and to the long distance range on the other. Enlarging the light receiver, i.e., for example the chip that is hit by the light being reflected back, would lead to an enlarged installation space for the distance measuring device inside of the floor processing device, which is not desired. If a distance measuring device is to be designed for the long distance range, then, short distances to an obstacle can no longer be acquired in a close distance range. This would make navigating the floor processing device impossible.

Known from DE 10 2008 014 912 A1 is an automatically movable floor dust collecting device with an obstacle detector, in which the light beams in a receiver unit are influenced in such a way that, after bundling via a receiver lens at least allocated to larger real distances to an obstacle, larger distances of incident light beams on a light-sensitive element arise. This is achieved by a corrective lens provided in addition to the receiver lens. In addition, another embodiment proposes that the triangulation device in combination with a single light receiver have two separate light sources. It is alternatively proposed that two separate light receivers be allocated to a single light source.

A differentiation between the signals of the close distance range and signals of the long distance range is routinely made by means of light sources with different wavelengths or corresponding downstream filter elements. If a single light source is used in conjunction with several light receivers, it is customary to only send a light signal if an electronic evaluation unit knows whether a close distance measurement or a long distance measurement is currently taking place, so as to then accordingly perform a detection only with a specific light receiver.

In addition, the aforementioned DE 10 2008 014 912 A1 also discloses a generic design in which two completely independent triangulation devices are designed for the same distance range. The triangulation devices are uniformly distributed over the periphery of the rotating plate.

### SUMMARY OF THE INVENTION

Proceeding from the aforementioned prior art, the object of the invention is therefore to further develop a floor processing device with a distance measuring device in terms of an optimal detectability of obstacles.

To achieve this object, it is proposed that the first triangulation device be designed to detect an obstacle in a close distance range to the floor processing device, and that the second triangulation device be designed to detect an obstacle in a long distance range to the floor processing device.

The invention now creates a distance measuring device in which completely separately operating triangulation devices are designed for the close distance range on the one hand, and for the long distance range on the other. A first triangulation device is here optimized for the close distance range, preferably for distances to obstacles of less than approx. 5 meters, while a second triangulation device is optimized for distances to obstacles that can measure more than approx. 5 meters. Each of the triangulation devices, i.e., both the first triangulation device as well as the second triangulation device, has its own light source, its own light receiver and its own lens allocated to the light receiver. The beam paths of the two triangulation devices are completely independent of each other. Components of the beam paths are not shared with each other. However and as preferred, only other facilities of the distance measuring device can be shared, for example a rotating plate, on which the two triangulation devices or parts thereof are arranged, and/or an evaluation device, which receives the signals of the two triangulation devices and determines a distance to an obstacle therefrom.

A first embodiment of the invention proposes that the first triangulation device and the second triangulation device be arranged one above the other at varying height levels relative to a surface on which the floor processing device moves. According to this configuration, for example, a second triangulation device is arranged above a first triangulation device, so that the distance measuring device can perform two distance measurements at different height levels of the environment. Each distance measurement here takes place optimized to a specific distance range, specifically optimized to a close distance range by means of the first triangulation device on the one hand, and optimized to a long distance range by means of the second triangulation device on the other. The inlet and outlet openings of the light sources or light receivers of the two triangulation devices are preferably aligned essentially in the same radial direction. Accordingly, the latter are preferably arranged one directly above the other, specifically in the same peripheral area of the distance measuring device. The two triangulation devices can thus measure in the same direction at the same time. Of course, it is alternatively possible for the inlet or outlet openings of the light sources to point in different peripheral directions, for example to be rotated by 180 degrees relative to each other, so that it can be almost completely precluded that light shares of the light emitted by the first triangulation device will hit the light receiver of the second triangulation device or vice versa, that light shares of the light source of the second triangulation device will hit the light receiver of the first triangulation device. Each height level, i.e., floor, of the distance measuring device, i.e., to include each triangulation device, has individual geometric parameters for the respective distance range to an obstacle to be covered. This relates to the distance between the light source and the light receiver, the focal length of the lens allocated to the light receiver, and the angle of attack of the outlet opening of the light source relative to a straight line that connects the outlet opening of the light source with the optical lens plane of the lens of the light receiver.

An alternative embodiment proposes that, in relation to a surface on which the floor processing device moves, the first triangulation device and the second triangulation device be arranged at the same height level parallel to the surface along an imaginary, essentially straight line. According to this embodiment, the optical components of the triangulation devices or their beam paths are located at only a single height level of the floor processing device, i.e., on only one floor. The triangulation devices are further not arranged in the peripheral direction of the distance measuring device, for example along a peripheral direction of a rotating plate on which the triangulation devices are located, but rather linearly along an essentially straight line. The essentially linear arrangement of the light sources and light receivers or their lenses here encompasses designs in which the components are minimally displaced in an orthogonal direction to this imaginary line, for example to balance out different dimensions of the housing of the light sources or light receivers and lenses. Deviations from the imaginary line measuring a few millimeters up to one or two centimeters are conceivable. However, the inlet openings or outlet openings of the light receivers and light sources preferably lie on a straight line, in particular so as to standardize and simplify calculations of the evaluation device for distance determination.

A preferred embodiment can provide that the first light source and the first light receiver of the first triangulation device be positioned along a line between the second light source and the second light receiver of the second triangulation device. This proposed telescoping arrangement of the components of the two triangulation devices makes it possible to reduce the overall required installation space of the distance measuring device. As proposed, the optical components of the second triangulation device here border the components of the first triangulation device. Since the second triangulation device is optimized for the long distance range, so that a distance between the second light source and the second light receiver must be greater than a distance between the first light source and the first light receiver of the first triangulation device, this configuration is especially optimal. Provided in this way is a module comprised of the components arranged inside for detecting relatively small distances to obstacles, and a module comprised of the components arranged outside for measuring comparatively larger distances to obstacles. In this version as well, the height of the distance measuring device remains low overall. There is only an increase in the length of the distance measuring device or the diameter of a rotating plate on which the distance measuring device is arranged.

As already explained, it is provided that the first light source and the first light receiver of the first triangulation device have less of a distance from each other than the second light source and the second light receiver of the second triangulation device. What this then means is that an output beam path of the first light source and an input beam path of the first light receiver include a smaller angle to each other than an output beam path of the second light source and an input beam path of the second light receiver of the second triangulation device.

It is further proposed that an optical axis of the first light source of the first triangulation device have a smaller angle of attack to a connecting line between the first light source and the first light receiver than an angle of attack of an optical axis of the second light source of the second triangulation device to a connecting line between the second light source and the second light receiver. This means that the outlet opening of the first light source is tilted less strongly toward the first light receiver than the outlet opening of the second light source to the second light receiver.

The close distance range of the distance measuring device preferably comprises distances of the floor processing device to an obstacle of less than 5 m, preferably 0.2 m to 5 m, and the long distance range comprises distances of the floor processing device to the obstacle of greater than 5 m, preferably from 5 m up to about 15 m. In floor processing devices known in prior art, the distance measuring device is usually still able to detect distances in a range of up to about 5 m. This means that a floor processing device with a central, 360 degree distance measuring device can perform measurements within a circular area with a radius of 5 m, for example. For this reason, rooms to be processed cannot have any correspondingly larger dimensions. According to the configuration now being proposed here, however, the long distance range expands to distances of up to 15 m, which means that a room to be processed or measured can have a length of about 30 m or an area of approx. 900 m². The floor processing device is thus capable of cleaning not just home environments, but for example also sales rooms, storage rooms, event rooms and similar rooms, e.g., those which are used commercially or industrially. On the other hand, the floor processing device according to the invention can simultaneously also detect distances to very nearby obstacles, for example to those obstacles less than 20 cm away from the floor processing device.

It is proposed that parts of the triangulation device, at least the light receiver and the lens, be arranged on a rotating plate that can rotate around an axis of rotation, wherein the axis of rotation is oriented orthogonally to a surface on which the floor processing device moves. The proposed rotating plate on which the triangulation devices as a whole, or at least the light receiver and the lens, are located, makes it possible to perform a 360 degree measurement around the center of the floor processing device in an especially favorable manner. If only the light receivers and the lenses of the first and second triangulation devices are arranged on the rotating plate, the light sources of the distance measuring device are arranged on a fixed partial area of the floor processing device, wherein the output beams of the light sources are deflected in such a way as to hit obstacles in the environment, and then hit the respective light receivers rotated by means of the rotating plate. If more than one triangulation device is provided for both the respective close distance range and the long distance range, swivel angles of less than 360 degrees are also sufficient. The 360 degree rotation around preferably one vertical axis of rotation of the floor processing device (given a horizontal alignment of the floor processing device) additionally prevents the emergence of blind spots of the distance measuring device. The entire environment of the floor processing device can be checked for obstacles by means of just a single distance measuring device with at least two triangulation devices according to the invention. The distance measuring device can be made to rotate by means of the rotatable rotating plate in relation to a fixed device housing of the floor processing device. For example, the rotating plate can be a partial area of a hood that overlaps a chassis of the floor processing device. Alternatively, the entire device hood overlapping the chassis can comprise the rotating plate. As an alternative to a continuously rotating rotating plate, the latter can also perform a back and forth movement, like a swivel movement, and in so doing scan a defined angle range. This is especially recommended for a distance measuring device having more than one triangulation device for the respective close distance range and long distance range. Alternatively, an angle range of more than 360 degrees can be scanned by correspondingly configuring the drive unit and mechanisms of the rotating plate. The rotating plate is preferably driven by an electric motor arranged in the floor processing device. The electric motor can act on the rotating plate via a toothed wheel or traction center gear. A configuration in which the drive for the rotating plate is coupled to a drive for traversing wheels of the floor processing device proves advantageous. This makes it possible to achieve a direct correlation between the continued movement of the floor processing device over a surface and the scanning of the environmental area of the floor processing device. For example, the coupling can be realized by means of the toothed wheel or traction center gear. The rotating plate and the distance measuring device arranged thereon, including the triangulation devices, are preferably covered by a cover. In this configuration, the rotating parts are protected against direct access by a user and against external environmental influences. In order to ensure the proper function of the distance measuring device, the cover is at least partially transparent in design, or designed with an optical window transparent to the detection radiation. Areas are correspondingly provided through which the light beams can exit the housing of the floor processing device into the environment or light beams reflected by obstacles can again get into the floor processing device and to the distance measuring device. The height of the distance measuring device, in particular given a design with triangulation devices arranged one above the other, is correspondingly adjusted in terms of height to the transparent or recessed cover area. In a further configuration, the transparent or recessed area of the cover can also be designed as an optical aperture and/or optical filter element, further for example by coating a transparent area. A sensor is provided to acquire the angle of rotation of the rotating plate relative to a fixed device housing of the floor processing device, and acquires an angle between a specific exemplary position of the distance measuring device and a longitudinal axis of the floor processing device or its device housing via an angle measurement. As a result, the evaluation device of the floor processing device can continuously scan the environment given a rotatable or swivelable arrangement of the distance measuring device, and allocate the information obtained in the process to a respective orientation relative to the environment. This enables a targeted navigation of the floor processing device. Various measuring methods can be used to establish an angle sensor, for example with the use of optical sensors, light barriers, potentiometers, Hall sensors or contact sensors.

Finally, it is proposed that the floor processing device be a floor processing device designed for industrial or commercial environments of more than 100 m², in particular more than 200 m², up to 900 m² of surface to be processed. The distance measuring device is correspondingly designed so that the distances to obstacles in such an environment can be precisely measured. In a distance measuring device arranged on a rotating rotating plate centrally in the floor processing device, this means that a circular plane with a diameter of up to 30 m can be scanned.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a perspective view of a floor processing device according to the invention;

FIG. 2 is a schematic sketch of a beam path of an optical triangulation device;

FIG. 3 is a distance measuring device according to a first embodiment; and

FIG. 4 is a distance measuring device according to a second embodiment.

### DETAILED DESCRIPTION OF PREFERRED EMBODIMENTS

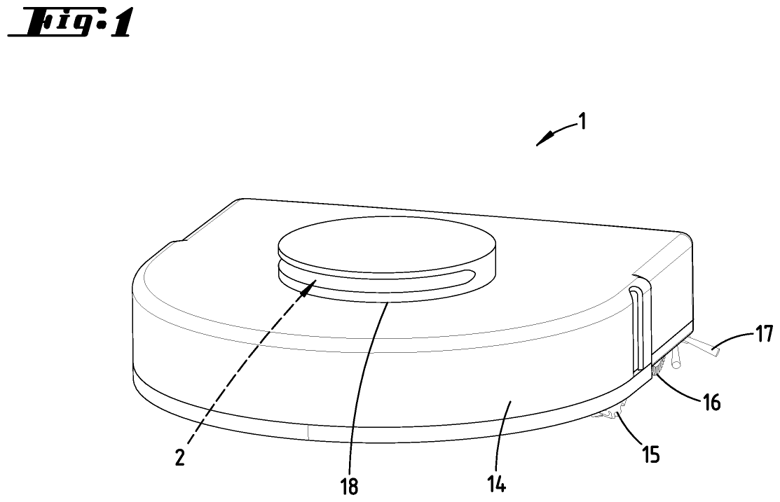

FIG. 1 initially shows a floor processing device 1 according to one possible configuration. The floor processing device 1 is a self-propelled floor processing device 1 with an electric motor drive device to drive driving wheels 15 of the floor processing device 1 arranged on the underside of a device housing 14. For example, the floor processing device 1 is here designed as an autonomous cleaning device, in particular a vacuuming robot. Floor processing elements 16, 17 are arranged on an underside of the device housing 14, of which a first floor processing element 16 is a brush roller that rotates around an essentially horizontal axis, for example. For example, a second floor processing element 17 is a side brush of the floor processing device 1 that rotates around an essentially vertical axis, which is suitable in particular for cleaning transitional areas between a floor surface and wall or an obstacle. A distance measuring device 2 as well as an evaluation device for evaluating the information detected by the distance measuring device 2 are arranged in the device housing 14 of the floor processing device 1. The distance measuring device 2 is used to detect a distance between the floor processing device 1 and an obstacle 3 in the environment. For example, the distance measuring device 2 here has two separate triangulation devices 4, 5, which emit light according to the measuring principle of optical triangulation and receive light shares reflected back by an obstacle 3. Even though not shown, the distance measuring device 2 can also have more than two separate triangulation devices 4, 5. One or several openings 18 for transmitting or receiving light are provided on an upper side of the device housing 14 of the floor processing device 1, through which the light of the distance measuring device 2 can pass. The shape of the device housing 14 is here exemplarily comprised of a semicircular section and an adjoining rectangular section. The driving wheels 15 provided on the underside of the device housing 14 are downstream from the floor processing elements 16, 17. In addition to the floor processing elements 16, 17, a suction mouth opening can further be provided (not shown here), in which dust and dirt can be sucked in by means of a suction blower of the floor processing device 1.

The floor processing device 1 further has a navigation device not shown in more detail, which uses data detected by the distance measuring device 2, for example in the form of an area map, so as to navigate the floor processing device 1 collision-free within the environment and localize itself.

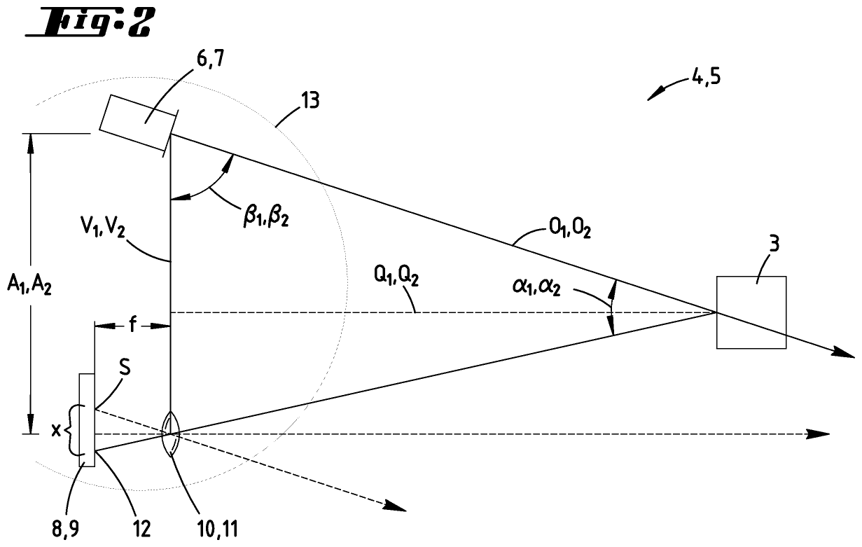

The distance measuring device 2 has at least two triangulation devices 4, 5. The measuring principle of the triangulation device 4, 5 is explained with reference to FIG. 2. As optical elements, the triangulation device 4, 5 has a light source 6, 7, a light receiver 8, 9 and a lens 10, 11 upstream from the light receiver 8, 9 in the radiation direction. An outlet opening of the light source 6, 7 and the midpoint of the lens plane of the lens 10, 11 are connected with each other by a connecting line V₁, V₂ at a distance A₁, A₂. The light source 6, 7 is inclined at a defined angle of attack β₁, β₂ relative to the connecting lines V₁, V₂. The light exiting the light source 6, 7 propagates along an optical axis O₁, O₂ to an obstacle 3, and from there is reflected to the lens 10, 11, and imaged by means of the lens 10, 11 having a focal length f onto the light receiver 8, 9. The distance between the reflecting point of the obstacle 3 and the connecting lines V₁, V₂ relative to a vertical projection of the reflecting point on the connecting line V₁, V₂ is the measuring distance Q₁, Q₂. An angle α₁, α₂ exists between a light beam of the light source 6, 7 along the optical axis O₁, O₂ and a light beam reflected by the obstacle 3 to the light source 6, 7. The light reflected by the obstacle is imaged by means of the lens 10, 11 on a defined imaging location 12 of the light receiver 8, 9, the position of which depends on the measuring distance Q₁, Q₂, specifically the distance between the obstacle 3 and the connecting lines V₁, V₂, or roughly speaking the distance between the obstacle 3 and the floor processing device 1 or its distance measuring device 2. With a focal length f of the lens 10, 11, a distance x of the imaging location 12 relative to an intersection S of the light receiver 8, 9 with a line oriented parallel to the transmitted light and the distance A₁, A₂ between the light source 6, 7 and lens 10, 11, the measuring distance Q₁, Q₂ is calculated as follows:

$$Q 1 , Q 2 = \frac{f * A 1 , A 2}{x} .$$

As evident based on this formula, a product of the focal length f and the distance A₁, A₂ between the light source 6, 7 and lens 10, 11 should be as small as possible for measuring short distances Q₁, Q₂ between the floor processing device 1 and the obstacle 3, for example which arise in the process of docking the floor processing device 1 to a base station. Due to the small dimensions, however, this leads to a relatively high measuring deviation. Accordingly, a relatively large value for the product of focal length f and distance A₁, A₂ is recommended for large measuring distances Q₁, Q₂. In order to measure distances to far away obstacles 3, it is correspondingly required that the light source 6, 7 and the lens 10, 11 be spaced especially far apart from each other, or that a lens 10, 11 with a large focal length f be used as an alternative or most preferably in addition. This correspondingly leads to a demand for more installation space for the distance measuring device 2 inside of the floor processing device 1. Therefore, neither very small measuring distances Q₁, Q₂ nor very large measuring distances Q₁, Q₂ can be measured with the same triangulation device 4, 5 with a sufficient measuring accuracy. Instead, it is recommended, as now proposed by the solution according to the invention, that two separate triangulation devices 4, 5 be used for measuring different measuring distances Q₁, Q₂, specifically a first triangulation device 4 for relatively small measuring distances Q₁ and a second triangulation device 5 for relatively large measuring distances Q₂.

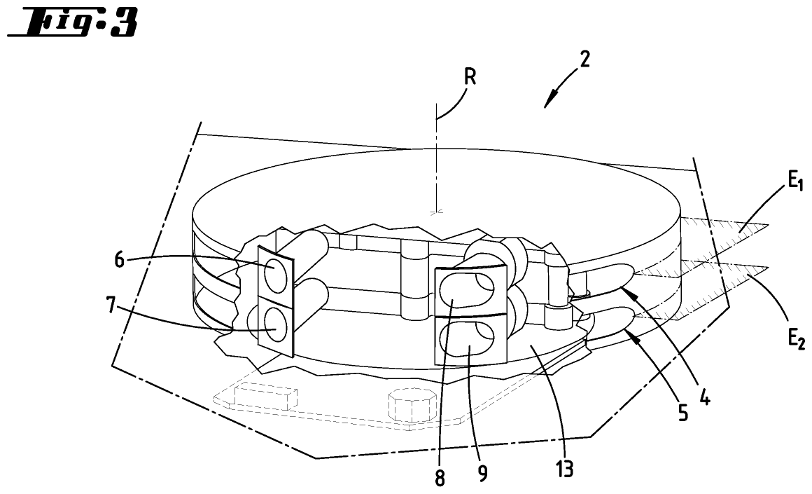

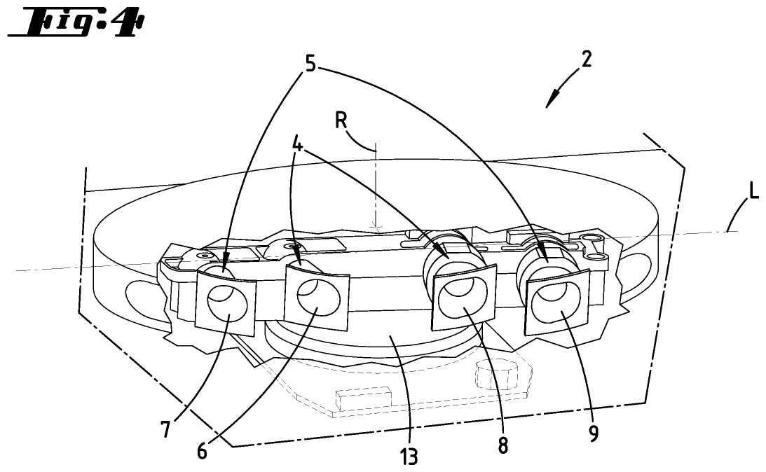

FIGS. 3 and 4 show two different possible embodiments for distance measuring devices 2 according to the invention. The depicted distance measuring devices 2 are preferably located on an upper side of the device housing 14 (as illustrated on FIG. 1).

The embodiment illustrated on FIG. 3 shows a distance measuring device 2 with a first triangulation device 4 and a second triangulation device 5, which are arranged at different height levels E₁, E₂ along an axis of rotation R one above the other. For example, the axis of rotation R is here an axis of rotation R around which a rotating plate 13 rotates, on which the distance measuring device 2 is arranged. According to the exemplary embodiment shown, the upper first triangulation device 4 is configured for a close distance range between the floor processing device 1 and an obstacle 3 to be measured, while the lower second triangulation device 5 is optimized to measure obstacles 3 in a long distance range. For example, the close distance range here includes distances to an obstacle 3 of 0.2 m to 5 m, while the long distance range comprises measuring distances Q₁, Q₂ of greater than 5 m up to 15 m, for example. The indicated measuring distances Q₁, Q₂ for the first triangulation device 4 on the one hand and the second triangulation device 5 on the other are only exemplary. Of course, the elements of the triangulation devices 4, 5, specifically the light sources 6, 7, the light receivers 8, 9 and the lenses 10, 11, can also be spaced apart in such a way that other measuring distances Q₁, Q₂ can be detected in an especially optimal manner.

For a very close measuring range of less than 0.2 m, the floor processing device 1 has an additional sensor system, for example which can contain ultrasound sensors, imaging sensors such as Lidar or CCD sensors, or also a so-called bumper as an impact sensor. As the floor processing device 1 moves toward an obstacle 3, distances are initially measured by means of the distance measuring device 2 described in more detail below, at first in a long distance range, and thereafter in a close distance range. When the floor processing device 1 subsequently has a distance from an obstacle 3 that is less than the lower limit of the near range, here specifically is smaller than 0.2 m, the additional sensor system takes over monitoring for the very close range. During the continued approach toward the obstacle 3, the speed of the floor processing device 1 is adjusted in such a way as to preclude a collision between the floor processing device 1 and the obstacle 3, or at least a rough collision that could cause damage to the floor processing device 1 and/or the obstacle 3.

According to FIG. 3, the distance measuring device 2 has a two-story design, with two triangulation devices 4, 5 lying one above the other. The first light source 6 and the first light receiver 8 are here placed at a smaller angle α₁, α₂ to each other than the second light source 7 and the second light receiver 9 of the second triangulation device 5. Accordingly, the measuring distance Q₁ of the first triangulation device 4 is also less than the measuring distance Q₂ of the second triangulation device 5.

FIG. 4 shows a possible alternative embodiment according to the invention, in which a first distance measuring device 2 is arranged between the light source 7 and the light receiver 9 of a second triangulation device 5. This results in just a one-story design for the distance measuring device 2. The optical components of the two triangulation devices 4, 5 are aligned along an imaginary straight line L. As a consequence, the positions of the light sources 6, 7 and light receivers 8, 9 do not follow a peripheral contour of the rotating plate 13, but of the line L. By telescoping the two triangulation devices 4, 5, installation space can be achieved in relation to the length of the entire arrangement of the distance measuring device 2 along the line L. The components of the second triangulation device 5, for which the distance A₂ between the light source 7 and the light receiver 9 must be relatively large so as to enable precise measurement in a long distance range, correspondingly outwardly flank the first light source 6 and the first light receiver 8 of the first triangulation device 4, which must stand as closely together as possible for optimal measurement in a close distance range, i.e., should have a small distance A₁ from each other. The varyingly large distances A₁, A₂ of the first triangulation device 4 and the second triangulation device 5 correspondingly also result in a different angle of attack β₁, β₂ of the light source 6, 7 relative to the connecting lines V₁, V₂, or in differing angles α₁, α₂ between the incident beam path of the light source 6, 7 and the outgoing beam path, which runs from the obstacle 3 up to the lens 10, 11 or the light receiver 8, 9.

The measuring distance Q₁, Q₂ to an obstacle 3 can be determined based on the imaging location 12 of the light reflected by the obstacle 3 on the light receiver 8, 9. Depending on the measuring distance Q₁, Q₂, the reflected light falls on a specific imaging location 12 of the light receiver 8, 9 after bundled by the lens 10, 11. For example, the light receiver 8, 9 is a two-dimensionally or three-dimensionally designed chip or an array of photodiodes. As the obstacle 3 moves further away from the light receiver 8, 9, there is an increasing distance x between the imaging location 12 and the location on the light receiver 8, 9 that corresponds to an intersection S with a straight line running parallel to the optical axis O₁, O₂. The distance x of the imaging location 12 can be used to clearly calculate the distance or measuring distance Q₁, Q₂ to the obstacle according to the correlation

$$Q 1 , Q 2 = \frac{f * A 1 , A 2}{x}$$

As a whole, then, the invention provides a distance measuring device 2 in which all components, such as light sources 6, 7, lenses 10, 11 and light receivers 8, 9, are doubled, so that two independent distance sensor systems are available, which are arranged either one above or next to, i.e., inside of, the other, and can measure distances to obstacles 3 in a close distance range on the one hand, and distances in a long distance range with equally good accuracy on the other.

It goes without saying that the ranges for close distances and long distances exemplarily mentioned here can also have different values, in particular based upon a change in the physical parameters of the distance measuring device 2. For example, the boundary between the close distance range and long distance range does not have to be 5 m, but can measure 1 m, 2 m, 3 m, 4 m, 6 m, 7 m, 8 m, 9 m, 10 m or fractions thereof, e.g., 4.1 m, 4.2 m, 4.3 m, and so on.

Although only a few embodiments of the present invention have been shown and described, it is to be understood that many changes and modifications may be made thereunto without departing from the spirit and scope of the invention.

Reference List

| | | | |
|---|---|---|---|
| 1 | Floor processing device | | |
| 2 | Distance measuring device | | |
| 3 | Obstacle | | |
| 4 | First triangulation device | | |
| 5 | Second triangulation device | E₁ | Height level |
| 6 | First light source | E₂ | Height level |
| 7 | Second light source | L | Line |
| 8 | First light receiver | A₁ | Distance |
| 9 | Second light receiver | A₂ | Distance |
| 10 | First lens | α₁ | Angle |
| 11 | Second lens | α₂ | Angle |
| 12 | Imaging location | β₁ | Angle of attack |
| 13 | Rotating plate | β₂ | Angle of attack |
| 14 | Device housing | O₁ | Optical axis |
| 15 | Driving wheel | O₂ | Optical axis |
| 16 | Floor processing element | R | Axis of rotation |
| 17 | Floor processing element | f | Focal length |
| 18 | Opening | Q₁ | Measuring distance |
| | | Q₂ | Measuring distance |
| | | V₁ | Connecting line |
| | | V₂ | Connecting line |
| | | x | Distance |
| | | S | Intersection |

What is claimed is:

1. A self-propelled floor processing device (1) comprising:
an optical distance measuring device (2) configured for detecting a distance between the floor processing device (1) and an obstacle (3) in the environment, wherein the distance measuring device (2) comprises:
a first triangulation device (4) comprising a first light source (6), a first light receiver (8) and a first lens (10) allocated to the first light receiver (8),
a second triangulation device (5) designed separately from the first triangulation device (4) and comprising a second light source (7), a second light receiver (9) and a second lens (11) allocated to the second light receiver (9), and
an evaluation device, wherein the first and second lenses (10, 11) are configured to bundle light of the respective first and second light sources (6, 7) reflected by an obstacle (3) in the direction of the allocated light receiver (8, 9), and image the light on an imaging location (12) on the respective light receiver (8, 9), and wherein the evaluation device is configured to determine a distance to the obstacle (3) based on the imaging location (12), wherein the first triangulation device (4) is designed to detect an obstacle (3) in a first distance range to the floor processing device, and wherein the second triangulation device (5) is designed to detect an obstacle (3) in a second distance range to the floor processing device (1) that is longer than the first distance range.

2. The floor processing device (1) according to claim 1, wherein the first triangulation device (4) and the second triangulation device (5) are arranged one above the other at various height levels (E₁, E₂) relative to a surface on which the floor processing device moves.

3. The floor processing device according to claim 1, wherein the first triangulation device (4) and the second triangulation device (5) are arranged at a same height level (E₁, E₂) parallel to a surface on which the floor processing device moves, along an imaginary, substantially straight line (L) relative to the surface on which the floor processing device (1) moves.

4. The floor processing device (1) according to claim 3, wherein the first light source (6) and the first light receiver (8) of the first triangulation device (4) are positioned along the line (L) between the second light source (7) and the second light receiver (9) of the second triangulation device (5).

5. The floor processing device (1) according to claim 1, wherein the first light source (6) and the first light receiver (8) of the first triangulation device (4) are spaced apart from each other by a distance that is less than a distance between the second light source (7) and the second light receiver (9) of the second triangulation device (5).

6. The floor processing device according to claim 1, wherein an output beam path of the first light source (6) and an input beam path of the first light receiver (8) include a smaller angle (α1) to each other than between an output beam path of the second light source (7) and an input beam path of the second light receiver (9) of the second triangulation device (5).

7. The floor processing device (1) according to claim 1, wherein an optical axis (O₁) of the first light source (6) of the first triangulation device (4) has a smaller angle of attack (β₁) to a connecting line (V₁) between the first light source (6) and the first light receiver (8) than an angle of attack (β₂) of an optical axis (O₂) of the second light source (7) of the second triangulation device (5) to a connecting line (V₂) between the second light source (7) and the second light receiver (9).

8. The floor processing device (1) according to claim 1, wherein the first distance range of the distance measuring device (2) comprises distances of the floor processing device (1) to the obstacle (3) of less than 5 m, and wherein the second distance range comprises distances of the floor processing device (1) to the obstacle (3) of greater than 5 m.

9. The floor processing device (1) according to claim 1, wherein parts of the triangulation device (4, 5), at least the light receiver (8, 9) and the lens (10, 11), are arranged on a rotating plate (13) that is configured to rotate around an axis of rotation (R), wherein the axis of rotation (R) is oriented orthogonally to a surface on which the floor processing device (1) moves.

10. The floor processing device (1) according to claim 1, wherein the floor processing device (1) is a floor processing device (1) designed for industrial or commercial environments of more than 100 m² of surface to be processed.
